(19) United States
(12) Patent Application Publication
(10) Pub. No.: US 2004/0010446 A1
(43) Pub. Date: Jan. 15, 2004

(54) Mobile customer relationship management

(76) Inventors: Marko Vanska, Espoo (FI); Vesa Jutila, Espoo (FI); Ian Nordman, Sipoo (FI)

Correspondence Address: MORGAN & FINNEGAN, L.L.P., 345 PARK AVENUE, NEW YORK, NY, 10154, US

(21) Appl. No.: 10/191,735

(22) Filed: Jul. 8, 2002

(51) Int. Cl. G06F 17/60

(52) U.S. Cl. 705/14; 379/913

(57) ABSTRACT

Systems and methods for providing/receiving personalized messages relating to goods and/or services. An exemplary method for providing personalized messaging to a user of a mobile terminal includes: receiving user data comprising an act to be performed by the user and an instruction to be followed by the user when performing the act; comparing the user data with service data for goods or services that may assist the user in completing the acts in accordance with the instructions; and based on the comparison, providing personalized messaging to the mobile terminal concerning the goods or services. The user data compared with the goods or services also may include user profile data, calendar data and/or location information to further personalize the messaging. Some or all of this user data may be received directly from the mobile terminal or, alternatively, may be obtained from a network-based trusted server.

### FIELD OF THE INVENTION

This invention relates to wireless communications systems in general, and more particularly, to methods and systems of providing personalization of messages to users of mobile terminals.

### BACKGROUND OF THE INVENTION

The current mobile computing marketplace has increasingly focused on wireless access to both telecom and data network services. Within the data network context, such networks nowadays offer access to a plethora of different services offered by various entities. In addition to using more traditional forms of advertising, these entities often will advertise their services to user's of mobile terminals over a data network using “push” messages. Indiscriminate transmissions of these messages, however, consume valuable network resources without increasing the likelihood of a purchase by the recipient and also lead to a large expenditure of user time in filtering messages of little or no interest to the user. Much is needed in the way of personalizing the messages sent to the user in order to reduce or eliminate altogether the foregoing shortcomings.

### SUMMARY OF THE INVENTION

The above-identified problems are solved and a technical advance is achieved in the art by systems and methods for providing/receiving personalized messages relating to goods and/or services.

An exemplary method for a service provider to provide personalized messaging to a mobile terminal includes: receiving user data comprising intent data and notes data; comparing the user data with services or goods data; and providing personalized messaging concerning services or goods based on the comparison.

In an alternate embodiment, an exemplary method includes: receiving user data comprising an act to be performed by a user of a mobile terminal and an instruction to be followed by the user when performing the act; comparing the user data with service data for goods or services that may assist the user in completing the act in accordance with the instruction; and based on the comparison, providing personalized messaging to the mobile terminal concerning the goods or services.

In an embodiment directed to a method for a mobile terminal to receive personalized messaging, an exemplary method includes: transmitting user data comprising an act to be performed by a user of the mobile terminal and an instruction to be followed by the user when performing the act; and receiving personalized messaging for goods or services based on the transmitted user data.

In an alternate embodiment, an exemplary method includes: storing user data comprising a plurality of acts to be performed by a user of the mobile terminal and, for each one of the plurality of acts, an instruction to be followed by the user when performing the act; receiving the user's selection of one of the plurality of acts to be performed by the user; transmitting user data comprising the selected one of the plurality of acts and an associated instruction to a service provider; and receiving personalized messaging for goods or services from the service provider based on the transmitted user data to assist the user in completing the act in accordance with the associated instruction.

Other and further aspects of the present invention will become apparent during the course of the following description and by reference to the attached drawings.

### BRIEF DESCRIPTION OF THE DRAWINGS

FIG. 1 is a block diagram illustrating an exemplary network for providing personalized messaging in accordance with one embodiment of the present invention.

FIG. 2 is a flowchart illustrating an exemplary process by which personalized messaging is provided in accordance with one embodiment of the present invention.

FIG. 3 is a block diagram illustrating an exemplary mobile terminal in accordance with one embodiment of the present invention.

### DETAILED DESCRIPTION

In the following description of the various embodiments, reference is made to the accompanying drawings which form a part hereof, and in which are shown by way of illustration various embodiments in which the invention may be practiced. It is to be understood that other embodiments may be utilized and structural and functional modifications may be made without departing from the scope of the present invention.

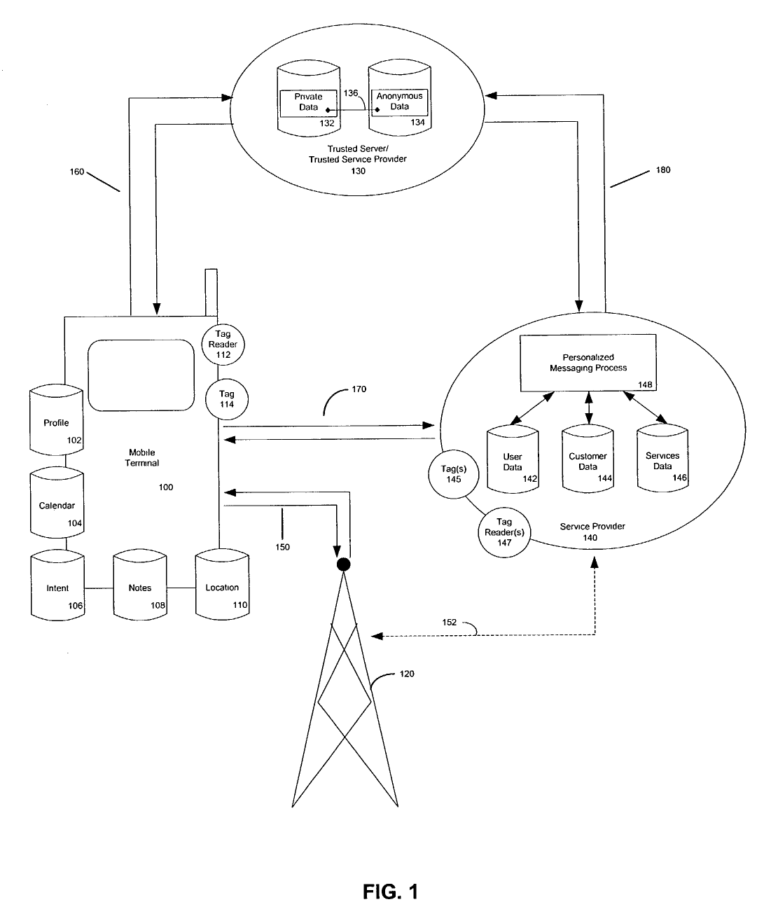

Referring now to the drawings, wherein like reference numerals refer to like parts, FIG. 1 is a block diagram illustrating an exemplary network for providing personalized messaging in accordance with one embodiment of the present invention. As shown in FIG. 1, a mobile terminal 100, which may be a hand-held wireless telephone, a personal digital assistant (“PDA”), a lap-top computer or the like, communicates with a service provider 140 over a wireless connection 170, such as General Packet Radio Service (“GPRS”) or Bluetooth, to receive personalized messages concerning services of interest to the user, as will be discussed in detail hereinafter. Service provider 140 may be a single entity, such as a single store, or an entity representing a plurality of stores, such as a shopping mall.

As shown in FIG. 1, mobile terminal 100 includes a variety of data bases for storing user data including, but not limited to, profile data base 102, calendar data base 104, intent data base 106, notes data base 108 and location data base 110.

Profile data base 102 stores user profile data such as a user's name, address, phone number(s), gender, age, employer, hobbies, car model, car registration number, preferences (e.g., a preferred genre of books), loyalty card memberships, credit/debit card information, and the like. Calendar data base 104 stores user generated entries for events such as appointments, birthdays, visits, holidays, vacations, shows, etc. correlated to a date and time when the event is to occur.

Intent data base 106 stores user-specified intended tasks or acts to be performed by the user such as “grocery shopping”, “birthday present shopping”, “car wash”, “hair cut”, etc. Notes data base 106 stores user-generated instructions to be followed by the user when performing a task. Exemplary notes stored in database 106 include a shopping list, a wish list for a family member, a spouse's perfume or cologne preferences, etc. In one embodiment, a user preferably may assign a priority such as High, Medium or Low to each task/note. Preferably, the user may activate these intents/notes at any time for a period of time (such as from now until otherwise indicated) or, as discussed further below, can associate them with a date/time in calendar data base 104 or to a location in location data base 110 for automatic activation.

Lastly, location data base 110 stores information concerning various locations of interest to the user (e.g., work, home, shopping mall, etc.). It also may store information concerning the user's current location as obtained via a wireless connection 150 from one or more location defining services 120. Such services include a global positioning system (GPS), a wireless WAN (e.g., GSM), a wireless LAN (e.g., IEEE 802.11), a wireless personal area network (e.g., Bluetooth or IrDA), an RF-ID wireless system or the like. Generally, location defining service 120 discerns mobile terminal 100's location in a manner well known in the art from transmissions received from terminal 100 and thereafter provides the location information to terminal 100 or, alternatively, to service provider 140 via connection 152 for use in the provisioning of personalized messages. Since the user's location is constantly changing, however, it will be appreciated that his current location information, unlike the above-mentioned stored locations of interest, may be obtained by mobile terminal 100 on an as-needed basis rather than being stored regularly in database 110.

As mentioned above, one method of determining a user's location, as represented in FIG. 1 by location defining service 120, involves the use of an RF-ID wireless system comprising RF-ID tags and an RF-ID reader, as will be discussed in detail hereinafter. An RF-ID tag is a wireless transponder that may contain varying amounts of information ranging from a tag identifier to a 128 K bytes of variable memory that can be programmed with additional information. An RF-ID reader communicates with a tag through the use of RF energy. In particular, an RF reader sends out an interrogation signal which “wakes up” a tag situated within a predetermined proximity to the reader. A tag may be “passive” in that it operates without an internal battery source, deriving the power to operate from the RF field generated by the RF-ID reader, which is inductively coupled to the tag. Alternatively, a tag may be “active”, and thus, powered by an internal battery that allows a greater communication range and higher data transmission rates. Once interrogated, the tag will transmit a signal including its ID number and possibly other information back to the RF-ID reader. RF-ID wireless network principles are described in a publication entitled “Radio Frequency Identification: A Basic Primer”, published by Automatic Identification Manufacturers (AIM), website: (www.aimglobal.org), Aug. 23, 2001, a copy of which is incorporated herein by reference.

In one embodiment of the present invention, the service provider 140 has one or more RF-ID tags 145 situated throughout its premises, each tag including an ID number that the service provider 140 has associated with a location in its premises. For example, a service provider 140 may install an RF-ID tag at the entrance of a shop and at certain points throughout the shop, such as at specific service or product displays. As shown in FIG. 1, the mobile terminal 100 is equipped with an RF-ID tag reader 112, which transmits interrogation signals that are received by one of the foregoing tags 145 as the user passes through the service provider 140's premises. The tag 145 will respond to the interrogation by transmitting a signal that includes its ID number to reader 112. Mobile terminal 100 may then store the ID number in location database 110 for transmission to service provider 140 either alone or in combination with other user data (e.g., profile, calendar, intent and/or notes data) over a wireless connection, such as connection 170. Transmission of the ID number to service provider 140 may be automatic or at the user's discretion. Thus, the user may select whether or not to transmit the ID number to the service provider 140, and thus, control whether or not service provider 140 is provided with the user's location. Moreover, since the service provider 140 may situate the tags 145 at service or product displays, the ID number of the tag may provide the service provider 140 not only with the user's location within the shop, but also with the user's interest in a particular service or product associated with a tag 145.

In an alternate embodiment, the service provider 140 has one or more RF-ID readers 147, rather than tags, situated throughout its premises, each reader 147 being associated with a location. The mobile terminal 100 includes an RF-ID tag 114, which, when activated by the user and brought into interrogation range of one of the RF-ID readers 147, transmits information associated with the tag 114, such as a customer identifier, to the reader 147. The service provider's reader 147 then may transmit this information to a central controller (e.g., a server) of service provider 140 over either a wired or wireless connection 152, which, in turn, can determine the location of the user based on the reader 147 from which the tag information was received. Once again, the user may control the transmission of location information to service provider 140, this time, by selecting whether or not to activate the tag 144 for interrogation in mobile terminal 100.

In one embodiment, the user may access the profile data base 102, calendar data base 104, intent data base 106, notes data base 108 and location data base 110 from a menu to perform maintenance such as adding, deleting, viewing, modifying or prioritizing entries. In addition, the user may associate data from any one of the databases (102-110) with data from one or more of the other data bases (102-110). In this regard, the user may associate data from one or more of these databases with spatial and/or temporal data, which, when matched with the user's current location and/or the current date/time automatically triggers a display of the data to the user as “suggested” user data to be sent to a service provider 140 with a service request. For example, a wish list for a family member in the notes data base 108 may be associated with a “birthday present shopping” task in the intents data base 106, which in turn, may be associated with an entry indicating a family member's birthday (or a reminder days or weeks, etc. in advance thereof) in the calendar data base 104 to prompt the user to transmit such user data to a service provider 140 to receive personalized messaging concerning services and/or goods that may satisfy this user data. This association may occur, e.g., by the user performing such functions as saving a task/note from intent/note databases (106,108) to calendar database 104.

Alternatively, or in addition thereto, the wish list in the notes data base 108 and the “birthday present shopping” task in the intents data base 106 may be associated with a shopping mall's location, and thus, be triggered for display to the user when the user's current location indicates that he is in or near the shopping mall. The user may then select these entries for transmission to a service provider for use in personalized messaging or, alternatively, may override mobile terminal 100's suggestion and select different user data to transmit to service provider 140. The user's current location may be received either from location defining service 120 as discussed above or explicitly provided by the user. Alternatively, the user's location may be discerned by mobile terminal 100 from information in calendar database 104. For example, entries in the user's calendar may reflect that he is at his place of work during the hours of 9:00 a.m. and 5:00 p.m., and thus, may be associated with a location identifier (e.g., latitude and longitude coordinates) in location database 110 that corresponds to his place of work. Similarly, the user may associate one or more of the foregoing categories of user data (i.e., calendar, intent, notes and/or location) with data, such as a shipping address, credit card information, etc., in profile data base 102.

As further shown in FIG. 1, mobile terminal 100 is also in wireless communication with a trusted server 130 over a data connection 160 such as GPRS and has an arrangement with the operator of server 130 to store therein some or all of the data stored in mobile terminal 100. The trusted server 130 may store the same data stored in terminal 100 and/or store data that the user has requested not be stored in terminal 100 due to storage limitations or for security reasons.

Mobile terminal 100 may transmit user data to trusted server 130 with different restrictions and/or usage rules associated therewith. For example, some of the user data may reveal the full identity of the user, and thus, may have user-defined restrictions on disclosure to service provider 140. This data is referred to herein as “private” data. One such restriction may be that the service provider 140 that is requesting the data present an encryption key that successfully decrypts the user data. The transmitted user data (whether transmitted directly from mobile terminal 100 or via trusted server 130) also may include user-defined rules for using the data, such as a requirement that a service provider 140 to whom the data is sent not forward it to third parties or that that the service provider 140 delete it from its data bases in accordance with user-defined expiration dates/times. In contrast, data that does not disclose the user's full identity may not have any disclosure restrictions and/or usage rules. This data is referred to herein as “anonymous” data. Trusted server 130 stores data identified by the user as “private” or “anonymous” in databases 132 and 134, respectively, with each type of data linked 136 to each other in a manner that is known only to the trusted server 130. For example, both the private data and the link 136 (e.g., a pointer) between it and the less sensitive anonymous data may be stored using an additional level of encryption known only to the trusted server 130.

In one embodiment, the user may create a group of data for transmission to, and storage in, trusted server 130 by: selecting data from one or more of the databases 102-110; assigning a privacy level (e.g., private or anonymous) together with disclosure restrictions and/or usage rules; and assigning an identifier to the group for use in retrieval. After transmitting the user data to trusted server 130, the user may thereafter access the server 130 to update the data by adding to it, deleting from it, or modifying any disclosure restrictions and/or usage rules. Additionally, the user may receive activity reports from trusted server 130. These reports may list the service providers 140 that requested user data as well as the user data, if any, that was disclosed to them. An activity report also may include the identities of service providers that have requested user data but to whom data was not disclosed owing to lack of authorization.

As further shown in FIG. 1, a user of mobile terminal 100 may establish a connection 170 with a service provider 140 to obtain information concerning goods and/or services via either a wide area data network such as GPRS or a short range wireless network such as Bluetooth. The connection may be initiated by service provider 140 transmitting a service message to mobile terminal 100, such as a cell-broadcasted message, that includes the address of available services. The addresses may correspond to one or more general services offered by service provider 140, such as apparel shopping or may correspond to one or more specific services such as athletic shoes. Alternatively, the connection may be initiated by the user of mobile terminal 100 using addresses corresponding to general or specific services that are pre-stored in terminal 100 or, alternatively, addresses that are “found” by mobile terminal 100 such as during “service discovery” upon entering a location where service provider 140 has a wireless presence. The user may browse the available services, select one of them and transmit a service request message to service provider 140.

A service request message includes an address corresponding to a particular service selected by the user and the user data selected by the user, e.g., from data bases 102-110 for transmission to service provider 140. In the event that user data is to be obtained from trusted server 130, mobile terminal 100 also will provide the service provider 140 with the address of the trusted server 130 together with an identifier associated with the data and any necessary authorization information, such as an encryption key or a digital certificate. The user data transmitted to service provider 140, either directly from mobile terminal 100 or via trusted server 130, preferably includes data from the user's profile, calendar, intent and notes.

Additionally, the user data transmitted to service provider 140 may include information concerning the user's current location as provided by location defining service 120. Alternatively, the user's location information may be obtained by the service provider 140 directly from location defining service 120. If such a service 120 is not available, however, the user may manually provide his current location (e.g., I am at 234 Main St.) or his future location information (e.g., “I will be at ABC shopping mall in 15 minutes.”). Such information also may be discerned by mobile terminal 100 itself from the user's entries in calendar data base 104.

The user data transmitted from the mobile terminal 100 to the service provider 140 for use in personalized messaging also may be transmitted in a mutually agreed upon format. A suitable presentation format for the user data is that of a “card” as discussed in detail in copending U.S. Patent Application entitled “A Method and Device for Storing and Accessing Personal Information”, filed in the name of Marko Vanska et al. on Jun. 17, 2002, a copy of which is incorporated herein by reference.

As discussed in that application, the user may select various user data to create and store a variety of cards including “loyalty” cards (e.g., customer relations management cards) and “payment” cards (e.g., credit cards). The cards created and stored by the user also may include “service” cards that either may be specific to a particular event or service (e.g., a particular bookstore or chain of bookstores) or, instead, may be generic for services or events of a particular type (e.g. bookstores in general). In addition, the cards may include “context” cards that the user may create and use to define his visibility toward services or businesses in a particular context (e.g., being in traffic, being in work, having free time, etc.), and thus, specify the types of services or businesses that he is receptive to receiving information from when in that context.

The user data that service provider 140 will use for personalized messaging may be communicated to mobile terminal 100 in the form of a card “template” for any of the above-mentioned card types. The template contains various attributes (e.g., NAME) and corresponding fields for the requested data. The user may then select and copy the requested data from profile data base 102, calendar data base 104, notes data base 106, intent data base 108 and location data base 110 into the appropriate fields of the template and then either transmit the card to service provider 140 in a service request message or, instead, store it for future use. The card, like other user data discussed above, may be stored with a spatial or temporal trigger associated therewith. Thus, selection of a stored card may occur manually or, alternatively, may occur automatically as a card selected by mobile terminal 100 for “suggested” use based on the user's present location or the current date/time.

As is evident from the foregoing, the user may store a plurality of such cards corresponding to, e.g., a plurality of different loyalty programs, payment methods, services and contexts. Thus, the user also may select and copy the requested information not only from data bases 102-110, but also from fields corresponding to the same attributes found on other cards stored in memory. Since the selection of user data is under the user's control, data may be selected such that disclosure does not disclose the user's full identity to the service provider 140.

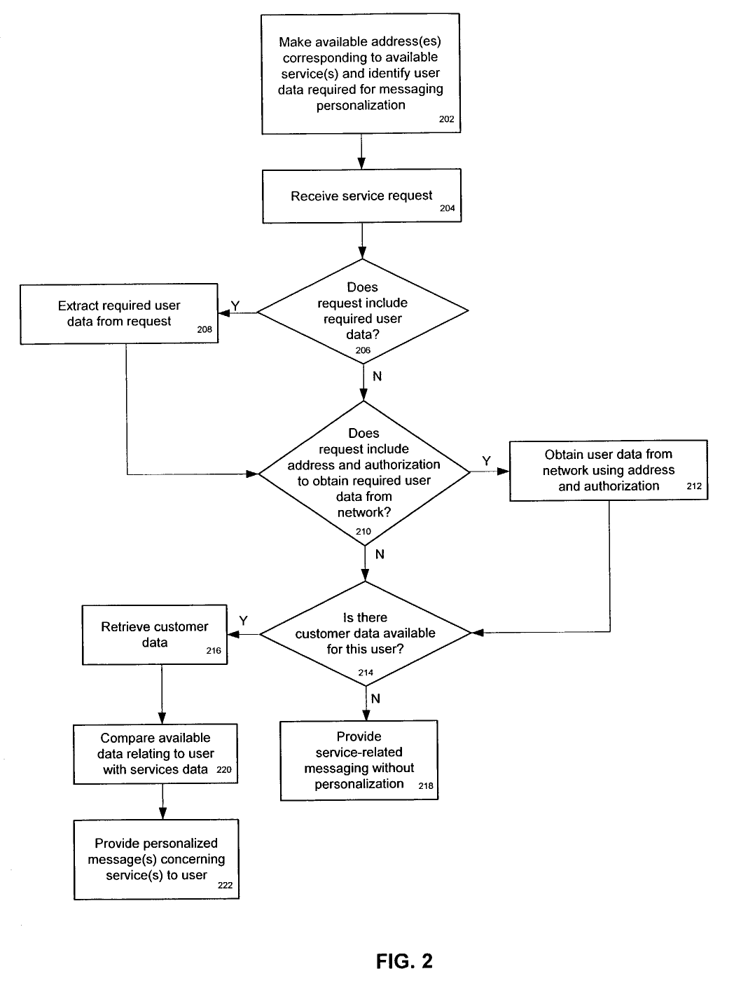

As further shown in FIG. 1, service provider 140 includes user data database 142, customer data database 144 and services database 146. User data database 142 stores user data that service provider 140 receives from mobile terminal 100 and/or trusted server 130 over connections 170 and 180, respectively, together with any data associated therewith, such as authorizations needed to access user data from trusted server 130 and usage rules. Customer data database 144 stores data concerning user's who have been customers of service provider 140, such as those user who are members of service provider 140's loyalty program. In this regard, service provider 140 also may transmit a request to mobile terminal 100 for additional information, such as an identifier (e.g., a card number) indicative of the user's membership in the service provider 140's customer loyalty program to further assist in personalized messaging. This data may include registration data such as the customer's name, address, etc. and purchase history. Service data database 146 stores data concerning the services and/or goods offered by service provider 140. Service provider 140 also includes a personalized messaging process 148 for comparing received user data with stored service data in providing personalized messages to the user, as will be discussed in detail hereinafter in connection with FIG. 2.

FIG. 2 is a flowchart illustrating an exemplary process by which a service provider provides personalized messaging to users of mobile terminals in accordance with one embodiment of the present invention. As shown in FIG. 2, in step 202, service provider 140 provides mobile terminals 100 with information related to personalized messaging. For example, service provider 140 makes available the addresses corresponding to one or more services to mobile terminals 100 by, e.g., transmitting a service message, such as a cell-broadcasted message, that contains the addresses of the service. Alternatively, these addresses already may have been pre-stored in mobile terminal 100. Service provider 140 also may identify user data that it may need to provide mobile terminal 100 with personalized messaging. As discussed above, this may be accomplished, e.g., by providing mobile terminal 100 with card templates containing various attributes (e.g., NAME) and corresponding fields for the requested data. Such templates may have been downloaded, completed and stored by mobile terminal 100 well in advance of submitting a service request.

In step 204, service provider 140 receives a service request from a mobile terminal 100 including an identifier of a generic or specific service of interest to the user. The service request may contain user data in the form of a completed card that was generated from a card template using data in profile data base 102, calendar data base 104, notes data base 106, intent data base 108 and location data base 110 of mobile terminal 100. The request also may contain additional information such as an address of a trusted agent 130 from which such user data may be obtained and any data identifiers and authorization information.

In step 206, service provider 140 determines whether the service request includes any of the required user data. If it does, then in step 208, the user data is extracted from the request and stored in user database 142. Whether or not the service request includes any of the required user data, in step 210, service provider 140 determines whether the service request includes an address of a trusted server 130 from which required user data may be obtained. In this regard, the service request will also include an identifier that identifies the set of data to be disclosed and an authorization, if needed, to obtain the data. If the user data to be provided by trusted agent 130 includes only anonymous data, rather than private data, mobile terminal 100 may not have imposed any restrictions on access to the data, and thus, not have provided any authorizations. If the request includes an address of a trusted server 130 together with a data identifier and any necessary authorizations, service provider, in step 212, will obtain the user data from trusted server 130 and store the user data in user database 142.

Whether or not the service request includes an address of a trusted server 130, in step 214, service provider 140 determines whether there is customer data for this user in customer data database 144. In this regard, service provider 140 may send a message to terminal 100 to ask the user whether he is a member of its loyalty program and, if so, to request his member identification number. If there is customer data stored in customer data database 144, then, in step 216, service provider 140 will retrieve it.

If the request did not contain either required user data or an address of a trusted server 130 from which required user data could be obtained and there also was not any customer data stored for this user, then, in step 218, service provider 140 provides service-related messaging without any personalization. If, however, user data was obtained either directly from mobile terminal 100 or indirectly via trusted server 130 or customer data was retrieved from customer data database 144 then, in step 220, service provider 140 compares the available data relating to the user (preferably, user profile, calendar, intent, notes and location data) with data concerning available services to identify services and/or goods that may be of particular interest to the user. In step 222, service provider 140 provides personalized messages to mobile terminal 100 concerning the identified services and/or goods.

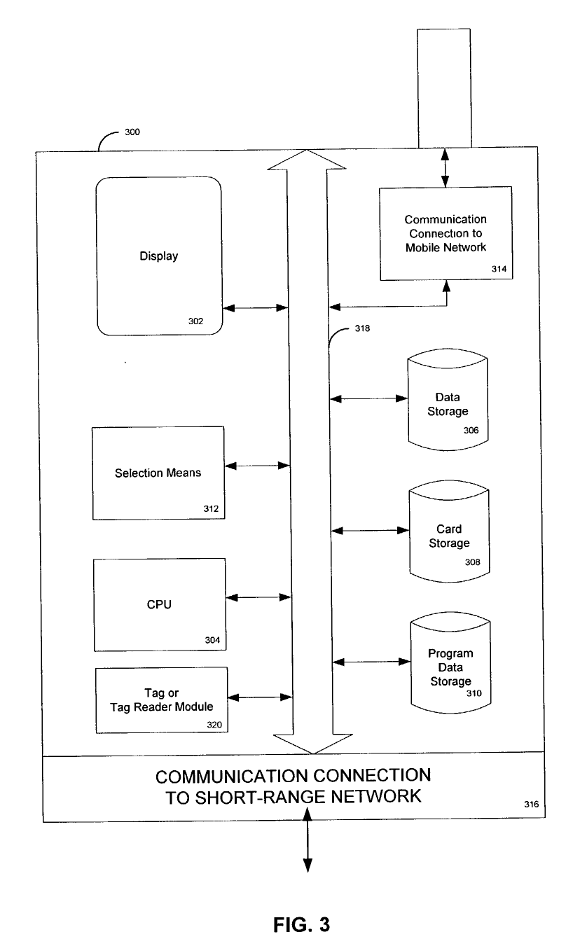

FIG. 3 is a block diagram illustrating an exemplary mobile terminal in accordance with one embodiment of the present invention. As shown in FIG. 3, mobile terminal 300 includes a display 302, preferably one with a touch screen capability, as is well-known in the art. The display 302 preferably is also capable of presenting textual, graphical and/or image data, including presentation formats corresponding to the cards used to transmit user data (e.g., profile, calendar, intent, notes and location information) used for personalized messaging.

Terminal 300 also includes a CPU 304 for controlling data processing and transfer operations within terminal 300. As shown in FIG. 3, terminal 300 further includes associated storage devices (306, 308, 310) for storing programs and various data for use in accordance with the present invention. Data storage 306 includes the above-mentioned user profile data base 102, calendar data base 104, intent data base 106, notes data base 108 and location database 110 together with any data associations, triggers, disclosure restrictions and usage rules. Storage 306 may also include the user's current location information, card templates, messages received from service providers, presentation format data, graphical or image data and the like. Card storage 308 stores the above-mention cards containing user data that have been created by the user from other cards or from templates downloaded from service providers 140. Program data storage 310 stores programs for data processing and transfer within mobile terminal 300.

Mobile terminal 300 also includes selection means 312 (e.g., a user interface, such as a keypad), which comprises numerous function keys such as alpha-numeric keys and directional (arrow) keys for scrolling through and selecting from among data contained in storage devices (306, 308, 310) and/or displayed on display, as will be discussed further below. Alternatively, or in addition thereto, a pointing device may be used for manipulating stored and/or displayed data.

As further shown in FIG. 3, mobile terminal 300 also includes a connection means 314 for communicating with a mobile network, such as a wireless WAN (e.g., GSM, GPRS, etc.) It also includes a connection means 316 for communicating with a short range wireless network such as a Personal Area Network (e.g., IrDA or Bluetooth PANs) or a wireless LAN (e.g., wireless IEEE 1394, IEEE 802.11 or HiperLAN/2). These connections may be used to communicate with location defining service 120, trusted server 130 and service provider 140 depending upon the network to which each of these entities is connected. Mobile terminal 300 may also include a tag or a tag reader module 320 for use in providing a service provider 140 with information concerning the user's current location in the manner discussed above in detail in connection with FIG. 1.

The above-described elements of terminal 300 are, in one embodiment of the present invention, interconnected via a data transfer bus 318. It will be readily appreciated that mobile terminal 300 also includes conventional hardware and functionality, which are employed in operating mobile terminal 300 as a mobile phone, but which are well known to those skilled in the art, and thus, are not shown in FIG. 3. Moreover, terminal 300 also may include means for password protecting user data selected for display, storage, transmission or other processing operations.

Returning to the selection means 312 shown in FIG. 3, these means enable a user to perform a variety of functions such as those already discussed above including but not limited to maintaining entries in user data bases 102-110, creating associations between different user data in data bases 102-110, assigning disclosure restrictions or usage rules to user data, assigning spatial and/or temporal triggers to user data, selecting and transmitting user data to trusted server 130, maintaining user data in trusted server 130, selecting user data from storage 306 for association with a presentation format such as a card, selecting a card template from among those received from a service provider for downloading into storage 306, selecting a card template from storage 306 for creating a card and selecting a created or downloaded card from storage 308 for transmission to a service provider 140.

Mobile terminal 300 may receive card templates via connection means (314, 316) and the user may select a template to be stored in data storage 304 and/or displayed on the display 306 for completion. The template fields then may be completed with data from data storage 306 manually by the user. Alternatively, the fields may be filled automatically by the mobile terminal 300 by searching for user data with the same attributes as those in the template. The user also may select one or more cards from storage for transmission with a service request to service provider 140 via connection means (314, 316) for use in providing personalized messaging. Additionally, the user may use the selection means 312 to select a presentation format for user data in cases where a plurality of presentation formats are available.

As discussed above, in one embodiment of the present invention, mobile terminal 300 may receive periodic updates of data relating to its present location via, e.g., communication connection means 314 (e.g., a WAN). This location data then may be stored in data storage 306 and used in accordance with the present invention in displaying relevant user data for possible user selection. The displaying of a suggested card also may depend upon other trigger data, such as time, either alone or in combination with location information.

The many features and advantages of the present invention are apparent from the detailed specification, and thus, it is intended by the appended claims to cover all such features and advantages of the invention which fall within the true spirit and scope of the invention.

Furthermore, since numerous modifications and variations will readily occur to those skilled in the art, it is not desired that the present invention be limited to the exact construction and operation illustrated and described herein, and accordingly, all suitable modifications and equivalents which may be resorted to are intended to fall within the scope of the claims.

We claim:

1. A method for a service provider to provide personalized messaging to a mobile terminal, comprising:
receiving user data comprising intent data and notes data;
comparing the user data with services or goods data; and
providing personalized messaging concerning services or goods based on the comparison.

2. The method of claim 1 wherein the user data further comprises one or more of user profile data, calendar data and user location information.

3. The method of claim 1 wherein the user data is received from a trusted server.

4. The method of claim 1 wherein the intent data comprises acts to be performed by a user of the mobile terminal and the notes data comprises instructions to be followed by the user when performing the acts.

5. The method of claim 1 wherein the user data is received in a presentation format corresponding to a card.

6. The method of claim 5 wherein the card is one of either a service card or a context card.

7. The method of claim 1 further comprising:
retrieving customer loyalty data for a user of the mobile terminal;
using the customer loyalty data together with the user data to provide personalized messaging to the user.

8. The method of claim 1 wherein the user data is anonymous.

9. A method for a service provider to provide personalized messaging to a mobile terminal, comprising:
receiving user data comprising an act to be performed by a user of the mobile terminal and an instruction to be followed by the user when performing the act;
comparing the user data with service data for goods or services that may assist the user in completing the act in accordance with the instruction; and
based on the comparison, providing personalized messaging to the mobile terminal concerning the goods or services.

10. The method of claim 9 wherein the user data further comprises one or more of user profile data, calendar data and user location information.

11. A method for a mobile terminal to receive personalized messaging, comprising:
transmitting user data comprising an act to be performed by a user of the mobile terminal and an instruction to be followed by the user when performing the act; and
receiving personalized messaging for goods or services based on the transmitted user data.

12. The method of claim 11 wherein the user data further comprises one or more of user profile data, calendar data and user location information.

13. The method of claim 12 further comprising:
transmitting user data to a trusted server for storage.

14. The method of claim 11 wherein the user data is anonymous.

15. The method of claim 11 wherein the user data is transmitted to a service provider.

16. The method of claim 15 wherein transmitting user data from the mobile terminal to a service provider comprises transmitting an identifier of a trusted server from which the user data may be obtained.

17. The method of claim 16 further comprising:
transmitting authorization information to the service provider for use in obtaining user data from the trusted server.

18. The method of claim 17 further comprising:
transmitting usage rules for the user data to the service provider.

19. The method of claim 11 further comprising:
transmitting a service request to the service provider.

20. The method of claim 19 wherein the service request is a specific service request.

21. The method of claim 19 wherein the service request is a general service request.

22. The method of claim 11 further comprising:
associating the act to be performed by the user with a calendar entry; and
prompting the user to transmit the act to a service provider when a current date or time matches a date or time of the calendar entry.

23. The method of claim 11 further comprising:
associating an act to be performed by the user with a location; and
prompting the user to transmit the act to a service provider when the user's location matches the location associated with the act.

24. The method of claim 11 further comprising:
associating an act to be performed by the user with user profile data.

25. The method of claim 11 further comprising:
receiving an indication from the user to transmit the act to be performed to the service provider.

26. The method of claim 11 further comprising:
receiving a request from a service provider for user data to be used in providing personalized messaging.

27. The method of claim 26, wherein the request includes a template.

28. The method of claim 11 wherein the user data is in a presentation format corresponding to a card.

29. The method of claim 28 wherein the card is either a service card or a context card.

30. The method of claim 11, further comprising:
downloading a template for user data from a service provider; and
completing the template with the user data.

31. The method of claim 30 wherein transmitting user data includes transmitting a completed template.

32. A method for a mobile terminal to receive personalized messaging, comprising:
storing user data comprising a plurality of acts to be performed by a user of the mobile terminal and, for each one of the plurality of acts, an instruction to be followed by the user when performing the act;
receiving the user's selection of one of the plurality of acts to be performed by the user;
transmitting user data comprising the selected one of the plurality of acts and an associated instruction to a service provider; and
receiving personalized messaging for goods or services from the service provider based on the transmitted user data to assist the user in completing the act in accordance with the associated instruction.

33. The method of claim 32 wherein the user's selection is prompted by a temporal or geographic trigger.

34. The method of claim 32 wherein the user data transmitted to the service provider further includes at least two of user profile data, calendar data and location information.

35. A mobile terminal for receiving personalized messaging, comprising:
a memory device for storing a program; and
a processor in communication with the memory device, the processor operative with the program to:
transmit user data comprising an act to be performed by a user of the mobile terminal and an instruction to be followed by the user when performing the act; and
receive personalized messaging for goods or services based on the transmitted user data.

36. The system of claim 35 wherein the processor is further operative with the program to:
associate the act to be performed by the user with a calendar entry; and
prompt the user to transmit the act to a service provider when a current date matches a date or time of the calendar entry.

37. The system of claim 35 wherein the processor is further operative with the program to:
associate the act to be performed by the user with a location; and
prompt the user to transmit the act to a service provider when the user's location matches the location associated with the act.

38. The system of claim 35 wherein the processor is further operative with the program to:
associate an act to be performed by the user with user profile data.

39. The system of claim 35 wherein the user data that is transmitted does not reveal the user's identity.

40. An article of manufacture comprising a computer readable medium containing program code that when executed causes a wireless handheld device to perform the following steps:
transmit user data comprising an act to be performed by a user of a mobile terminal and an instruction to be followed by the user when performing the act; and
receive personalized messaging for goods or services based on the transmitted user data.

41. The method of claim 1, wherein the service provider includes one or more RF-ID tags and the mobile terminal includes an RF-ID reader that is capable of reading the one or more RF-ID tags, the method further comprising:
associating each tag with a location;
transmitting a tag identifier from a tag to the reader of the mobile terminal;
receiving the tag identifier from the mobile terminal;
determining a location of the mobile terminal based on the tag identifier; and
providing personalized messaging concerning services or goods to a user of the mobile terminal based further upon the location.

42. The method of claim 41 further comprising:
receiving an interrogation at a tag.

43. The method of claim 1, wherein the service provider includes one or more RF-ID readers and the mobile terminal includes an RF-ID tag that is capable of being read by the one or more RF-ID readers, the method further comprising:
associating each reader with a location;
receiving, at a reader, a tag identifier from the tag of the mobile terminal;
determining a location of the mobile terminal based on the reader that received the tag identifier; and
providing personalized messaging concerning services or goods to a user of the mobile terminal based further upon the location.

44. The method of claim 43 further comprising:
interrogating the tag.

45. The method of claim 11, wherein the mobile terminal includes an RF-ID reader that is capable of reading one or more RF-ID tags associated with a service provider, the method further comprising:
interrogating a tag;
receiving a tag identifier from the tag;
transmitting the tag identifier to the service provider to enable the service provider to determine a location of the mobile terminal; and
receiving personalized messaging for goods or services based further upon the location.

46. The method of claim 45, wherein the step of transmitting the tag identifier to the service provider is performed only if authorized by a user of the mobile terminal.

47. The method of claim 11, wherein the mobile terminal includes an RF-ID tag that is capable of being read by one or more RF-ID readers associated with a service provider, the method further comprising:
receiving, at the tag, an interrogation from a reader;
transmitting a tag identifier to the reader to enable the service provider to determine a location of the mobile terminal; and
receiving personalized messaging for goods or services based further upon the location.

48. The method of claim 47, further comprising:
receiving an activation signal from a user of the mobile terminal to activate the tag to permit the disclosure of location information to the service provider.
